(19) United States
(12) Patent Application Publication
(10) Pub. No.: US 2019/0024427 A1
(43) Pub. Date: Jan. 24, 2019

(54) DRIVE ARRANGEMENT OF A FLAP ARRANGEMENT OF A MOTOR VEHICLE

(71) Applicant: Brose Fahrzeugteile GmbH & Co. Kommanditgesellschaft, Bamberg, Bamberg (DE)

(72) Inventors: Michael Wittelsbuerger, Bamberg (DE); Harald Krueger, Bamberg (DE); Michael Buchheim, Bamberg (DE); Matthias Seidl, Kueps-Schmoelz (DE); Christoph Belz, Lautertal (DE)

(21) Appl. No.: 16/080,961

(22) PCT Filed: Mar. 3, 2017
(86) PCT No.: PCT/EP2017/055033

§ 371 Date: Aug. 29, 2018

(30) Foreign Application Priority Data
Mar. 3, 2016 (DE) 10 2016 103 800.8

(51) Int. Cl. E05F 1/10; E05F 15/622

(52) U.S. Cl. CPC E05F 1/1058; E05Y 2900/50; E05Y 2201/474; E05F 15/622

(57) ABSTRACT

The disclosure relates to a drive arrangement of a flap arrangement of a vehicle, wherein the flap arrangement has a flap which can be displaced between an open position and a closed position, wherein the drive arrangement has two mechanical drive connections for the technical drive connection of the drive arrangement and a helical spring arrangement for producing a total resilient force between the two drive connections. It is proposed that the helical spring arrangement have at least one integral helical spring element, in particular a helical compression spring element, having a helical spring axis, that a displacement, in particular a closure displacement, of the flap be associated with a deflection of the helical spring element and that, in order to produce the curve progression of the total resilient force which has different curve gradients, the helical spring element has a progressive resilient behavior at least over a deflection portion.

### CROSS-REFERENCE TO RELATED APPLICATIONS

This application is a national stage application under 35 U.S.C. 371 of International Patent Application Serial No. PCT/EP2017/055033, entitled “Drive Assembly of a Hatch Assembly of a Motor Vehicle,” filed Mar. 3, 2017, which claims priority from German Patent Application No. DE 10 2016 103 800.8, filed Mar. 3, 2016, the disclosure of which is incorporated herein by reference.

### FIELD OF TECHNOLOGY

The present disclosure relates to a drive arrangement of a flap arrangement of a motor vehicle and a flap arrangement of a motor vehicle having such a drive arrangement.

### BACKGROUND

In view of the weights of rear flaps, which are particularly high in the case of station wagons, increasing importance is attributed to the support of the user during displacement of the flap counter to the weight force thereof In this case, the term “flap” is intended to be understood in a wide sense. It particularly includes a rear flap, a trunk lid, an engine hood, a side door, a storage space flap, a rising roof, or the like, of a motor vehicle.

The drive arrangement in question serves to support the user during the displacement of the flap. The drive arrangement may be purely resiliently driven or motor-driven.

The known drive arrangement (DE 100 01 054 A1), on which the disclosure is based, is provided with a drive motor for the motorized displacement of the flap. In addition, the drive arrangement has a resilient arrangement for producing a resilient force between two drive connections. The resilient arrangement is provided with two mutually separate resilient elements which apply a resilient force to the drive connections in accordance with the displacement of the flap. In this case, the arrangement is brought about in such a manner that one resilient element is active initially during a closure displacement and the second resilient element is active only in the region of the closure position of the flap. As a result of this “addition” of the additional resilient element in the region of the closure position of the flap, there is produced a non-constant curve progression of the total resilient force which acts on the drive connections over a displacement of the drive arrangement. Although an adjustment of the total resilient force intended as a first approximation between the drive connections is possible with this drive arrangement, for example, the additional resilient element can be configured so that a particularly high resilient force is provided for pressing the flap out of the closure position, the resultant drive arrangement is mechanically complex owing to the necessity for a plurality of to resilient elements. Furthermore, undesirable engagement noises and a visually very unappealing displacement operation additionally result owing to the abrupt coupling of the additional springs with the drive arrangement. The last aspect mentioned is generally considered to be a reduction in comfort.

### SUMMARY

The problem addressed by the disclosure is to configure and develop the known drive arrangement in such a manner that a flexible adjustability of the resilient force acting on the drive connections is possible with simple construction means.

The above problem is solved in a drive arrangement as described herein.

It has been recognized according to the proposal that the required curve gradients in the curve progression of the total resilient force can be produced in a particularly simple manner by using a helical spring element with progressive resilient behavior. In this case, the term “progressive resilient behavior” is intended to be understood in a wide sense and very generally means that the curve gradient of the curve progression of the helical spring force produced by the helical spring element is increased over the deflection of the helical spring element. This increase of the curve gradient can be carried out continuously or discontinuously over the deflection of the helical spring element. In particular, a curve progression of the helical spring force applied by the helical spring element over the deflection of the helical spring element is included thereby and is constituted by two linear curve portions which merge one into the other at an inflexion point which is acute to a greater or lesser extent.

It is proposed in detail that the helical spring arrangement which is responsible for producing the total resilient force between the two drive connections have at least one integral helical spring element which has an upper progressive resilient behavior. In this case, the arrangement is carried out in such a manner that a displacement, here in particular a closure displacement, of the flap is associated with a deflection of the helical spring element. Accordingly, the helical spring element produces with the progressive resilient behavior thereof a portion for the production of the different curve gradients in the total resilient force.

With the solution according to the proposal, different curve progressions of the total resilient force can be produced with little structural complexity. In principle, it is even conceivable for the use of a plurality of resilient elements which were previously always necessary to be able to be dispensed with.

It is possible to produce different curve portions of the curve progression of the total resilient force over a displacement of the drive arrangement with the use according to the proposal of a helical spring arrangement with progressive resilient behavior without the transition between the curve portions being connected with the coupling of an additional resilient element. As a result, the transition can be brought about in a gentler manner and substantially without any noise.

In principle, the helical spring element may be a helical tension spring element. However, the use of a helical compression spring element whose progressive resilient behavior can be mechanically produced particularly readily is disclosed.

In some embodiments, the progressive resilient behavior of the helical spring element is produced in that the helical spring element has a variable resilient configuration along the helical spring axis. This resilient configuration can be provided in portions or continuously, which becomes evident accordingly as a non-constant progressive resilient behavior or as a constant progressive resilient behavior.

Various embodiments relate to possibilities for changing the resilient configuration along the helical spring axis. In this case, a change of the turn pitch of the helical spring element along the helical spring axis assumes particular significance in this instance because it can be readily implemented mechanically, on the one hand, and, on the other hand, does not influence the geometry of the helical spring element at the peripheral side so that the solution according to the proposal does not give rise to additional problems caused by structural space.

In particular with a changing turn pitch along the helical spring axis, it is readily possible to produce an embodiment in which a deflection of the helical spring element results in spring turns of the helical spring element being applied and the resilient number of turns decreases. It is very generally the case here that a displacement of the flap is initially associated with a deflection and an application of the “soft” spring turns so that for the subsequent deflection only the “hard” spring turns still remain. This is because an application of the spring turns in the above sense means that the relevant spring turns are deflected as far as stopping so that an additional deflection is blocked by the adjacent spring turn, respectively.

In principle, it is conceivable according to some embodiments for the helical spring element to have a spring portion with “soft” spring turns which are applied simultaneously, that is to say, in portions. According to another embodiment, however, it is also conceivable for the spring turns to be applied successively during a displacement of the flap.

Particularly in the event that an above application of the spring turns is provided, it may be advantageous to subject the relevant spring turns to a surface treatment operation. This surface treatment operation is used to reduce noise which may be connected with the application of the spring turns. Alternatively or additionally, the surface treatment operation may also serve to reduce wear.

In some embodiments, an increase in the total resilient force in the last portion of the closure displacement of the flap is provided for. This means that, when the flap is closed, the closing resilient element is pretensioned with a great force so that an opening displacement of the flap is supported at least initially with a high total resilient force. This corresponds to the function of an arrangement which is widely known as a “push-up spring”.

In various embodiments, it is additionally the case that in the last portion of the closure displacement of the flap an increase in the curve pitch of the curve progression of the total resilient force is also provided. This takes into account the circumstance that in accordance with the function of an above-mentioned push-up spring a high pretensioning of the helical spring element is desirable over a small displacement range of the flap.

In principle, the drive arrangement according to the proposal can be driven purely resiliently via the helical spring arrangement. In some embodiments, however, the drive arrangement according to the proposal is motor-driven. The combination of a spindle/spindle nut mechanism according to some embodiments with the helical spring arrangement according to the proposal allows with a suitable configuration a particularly compact construction, particularly if the helical spring axis and the spindle axis are orientated coaxially relative to each other.

According to an additional aspect of teaching according to some embodiments, the flap arrangement with which the drive arrangement according to the proposal is associated is disclosed.

The flap arrangement according to the proposal has an above-mentioned flap which can be displaced between an open position and a closed position, wherein the flap can be displaced by means of the drive arrangement according to the proposal. Reference may be made to all the explanations in relation to the drive arrangement according to the proposal.

Some embodiments provide a drive arrangement of a flap arrangement of a motor vehicle, wherein the flap arrangement has a flap which can be displaced between an open position and a closed position, wherein the drive arrangement has two mechanical drive connections for the technical drive connection of the drive arrangement and a helical spring arrangement for producing a total resilient force between the two drive connections, wherein the curve progression of the total resilient force between the two drive connections over a displacement of the drive arrangement has different curve gradients in accordance with the drive position, wherein the helical spring arrangement has at least one integral helical spring element, in particular a helical compression spring element, having a helical spring axis, wherein a displacement, in particular a closure displacement, of the flap is associated with a deflection of the helical spring element and wherein, in order to produce the curve progression of the total resilient force which has different curve gradients, the helical spring element has a progressive resilient behavior at least over a deflection portion.

In various embodiments, the progressive resilient behavior is produced in that the helical spring element has a variable resilient configuration along the helical spring axis.

In various embodiments, the helical spring element has a resilient configuration which changes in portions or continuously along the helical spring axis.

In various embodiments, the helical spring element has at least one spring portion having a first resilient configuration and at least one spring portion having a second resilient configuration, such as wherein the helical spring element has at least one spring portion having at least one additional resilient configuration.

In various embodiments, the different resilient configurations of the helical spring element differ in terms of the spring geometry, such as wherein the different resilient configurations of the helical spring element differ from each other in terms of the turn pitch and/or wherein the different resilient configurations of the helical spring element differ from each other in terms of the turn diameter and/or wherein the different resilient configurations of the helical spring element differ from each other in terms of the spring wire diameter.

In various embodiments, the different resilient configurations of the helical spring element differ from each other in terms of the material parameters of the helical spring material.

In various embodiments, the resilient configuration of the helical spring element which changes along the helical spring axis causes spring turns of the helical spring element to be applied during deflection in the event of a displacement, in particular a closure displacement, of the flap at least in one displacement region of the flap, and the resilient number of turns to decrease.

In various embodiments, the spring turns of the helical spring element are applied in portions or wherein the spring turns are applied successively during a displacement of the flap.

In various embodiments, at least the applied spring turns are surface-treated, in particular dry coated.

In various embodiments, at least two spring portions of the helical spring element have per se a substantially linear resilient characteristic.

In various embodiments, in the second half, such as in the last third, such as in the last quarter of the closure displacement of the flap, the helical spring element brings about an increase in the total resilient force.

In various embodiments, in the second half, such as in the last third, such as in the last quarter of the closure displacement of the flap, the progressive resilient behavior of the helical spring element brings about an increase in the curve gradient of the curve progression of the total resilient force over the displacement of the drive arrangement.

In various embodiments, the drive arrangement has a drive motor and a feedgear mechanism which is connected downstream of the drive motor in order to produce drive movements which can be directed out via the drive connections.

In various embodiments, the feedgear mechanism is constructed as a linear mechanism in order to produce drive movements along a drive axis, in particular as a spindle/spindle nut mechanism, such as wherein the helical spring element is orientated along the drive axis, such as coaxially relative to the drive axis.

Various embodiments provide a flap arrangement of a motor vehicle having a flap which can be displaced between an open position and a closed position and a drive arrangement which is associated with the flap as described herein.

### BRIEF DESCRIPTION OF THE DRAWINGS

The disclosure is explained in greater detail below with reference to drawings which depict only one embodiment. In the drawings:

FIG. 1 shows the rear region of a motor vehicle which has a flap arrangement according to the proposal with a drive arrangement according to the proposal,

FIG. 2 is a longitudinal section of the drive arrangement according to FIG. 1 and

FIG. 3 is a highly schematic longitudinal section of the resilient element of the drive arrangement according to FIG. 2 with an associated curve progression of the total resilient force, a) with the flap located in the open position, b) with the flap located in an intermediate position and c) with the flap located in the closed position.

### DETAILED DESCRIPTION

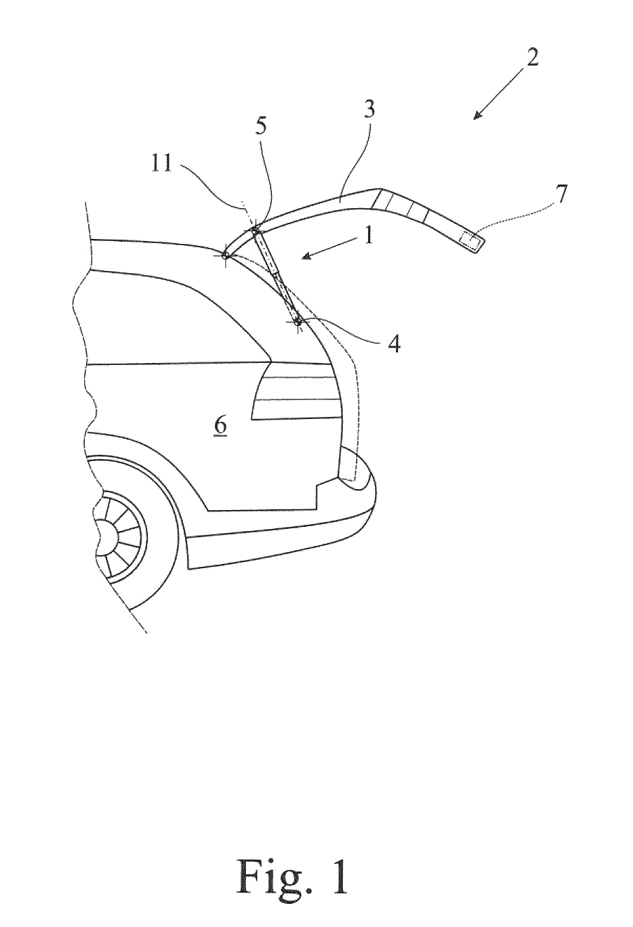

The drive arrangement 1 according to the proposal is associated with a flap arrangement 2 of a motor vehicle. The flap arrangement 2 has a flap 3 which can be displaced between an open position (illustrated in FIG. 1 with a solid line) and a closed position (illustrated in FIG. 1 with a broken line). The term “flap” is intended to be understood in a wide sense in the present case. In this regard, reference may be made to the introductory portion of the description.

The drive arrangement 1 has two mechanical drive connections 4, 5 for the technical drive connection of the drive arrangement 1. In the embodiment illustrated, the drive connection 4 is connected to the body 6 of the motor vehicle and the drive connection 5 is connected to the flap 3 in technical drive terms.

In a first embodiment, the drive arrangement 1 may be used simply to compensate for the weight force of the flap 3. In this case, the drive arrangement 1 is purely resiliently driven. However, it is the case, in this instance, that the drive arrangement 1 is used for the motorized displacement of the flap 3 between the open position and the closed position. The closed position may be a pre-closure position which is arranged slightly before the position of the completely closed flap 3. In such a case, there can be provision for a motor vehicle lock 7 which is arranged on the flap 3 to provide for a pulling closed function in order to move the flap 3 from the pre-closure position into the completely closed position.

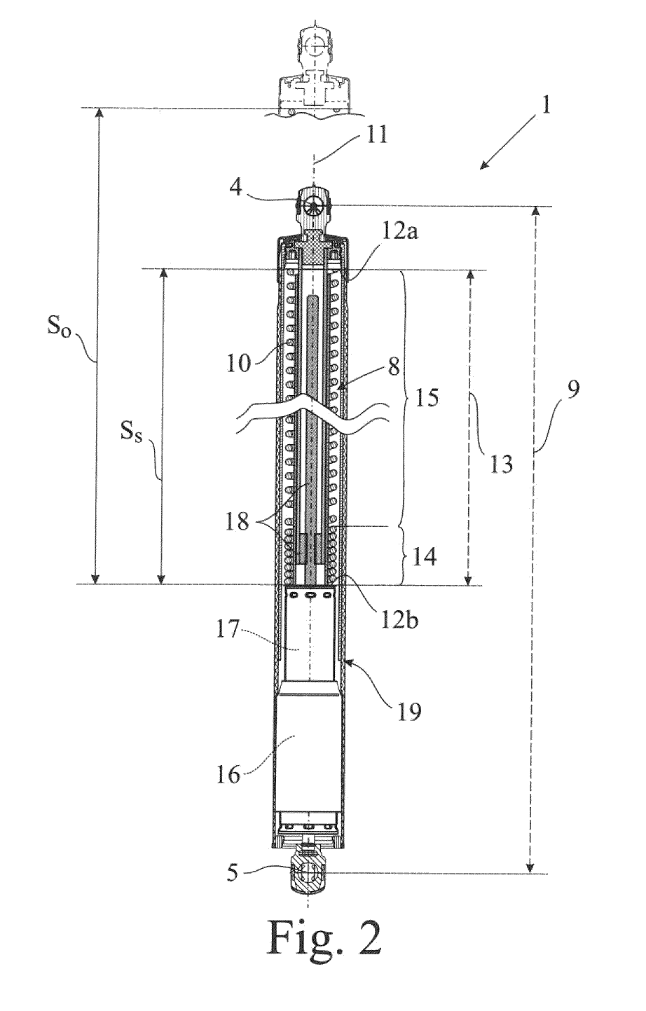

The drive arrangement 1 according to the proposal has a helical spring arrangement 8 which can be seen in FIG. 2. The helical spring arrangement 8 is used to produce a total resilient force 9 between the two drive connections 4, 5. In the embodiment illustrated, the helical spring arrangement 8 presses the drive connections 4, 5 apart. This may also be provided for in a transposed manner.

In order to comply with the kinematic peripheral conditions of the flap 3 and in particular the influence of the weight force of the flap 3, a special curve progression of the total resilient force 9 is provided between the two drive connections 4, 5 over a displacement of the drive arrangement 1, that is to say, over a displacement of the drive connections 4, 5 relative to each other. In this case, particular importance is attributed to the production of different curve gradients in accordance with the drive position, that is to say, the position of the drive connections 4, 5 relative to each other. This was explained in connection with the function of a push-up spring by way of example.

The important aspect is that the helical spring arrangement 8 has at least one integral helical spring element 10, which involves a helical compression spring element. In principle, however, the helical spring element 10 may also be a helical tension spring element. In the embodiment which is illustrated, the helical spring element 10 is the only helical spring element of the helical spring arrangement 8.

The helical spring element 10 can be constructed as a cylindrical helical spring. Other constructions, for example, a construction in the manner of a barrel spring, or the like, are also possible. There is associated with the helical spring element 10 a helical spring axis 11 which describes the longitudinal extent of the helical spring element 10. The helical spring axis 11 extends through the two drive connections 4, 5 here.

In the embodiment which is illustrated in FIG. 2, a displacement of the drive connections 4, 5 towards each other is connected with a deflection of the helical spring element 10. This is because an abutment face 12a for the helical spring element 10 is connected to the drive connection 4 and the other abutment face 12b for the helical spring element 10 is connected to the drive connection 5. In this regard, the drive arrangement 1 provides a telescope-like linear drive, as will be explained below.

Consideration of FIGS. 1 and 2 shows that a displacement, in this case a closure displacement, of the flap 3 is again associated with a deflection of the helical spring element 10. In order to produce the curve progression of the total resilient force 9 having different curve gradients, the helical spring element 10 has a resilient behavior which is progressive in the above sense. In this case, it is adequate in principle for this progressive resilient behavior to be provided over a limited deflection portion.

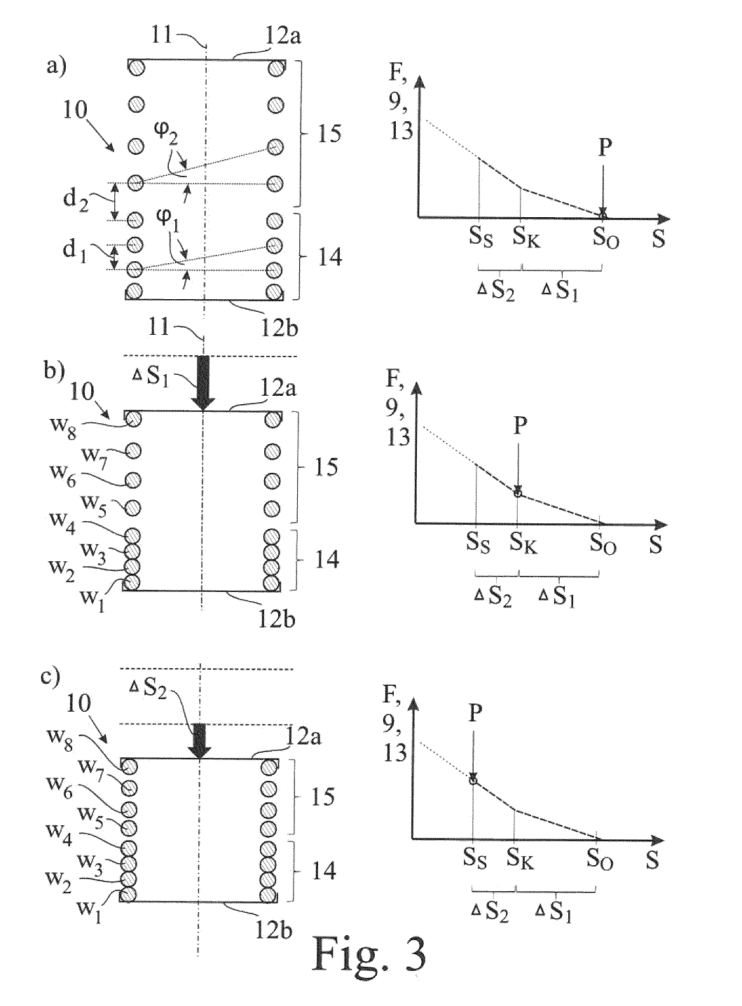

FIG. 3 illustrates, on the right-hand side, the curve progression of a force F, that is to say, the total resilient force 9 over a displacement of the drive arrangement 1. In this case, the arrow P describes the state which is illustrated in FIG. 3 on the left-hand side.

In the embodiment illustrated, the curve progression of the total resilient force 9 also shows as a first approximation the curve progression of the helical spring force 13 which is produced per se by the helical spring element 10 because the helical spring element 10 is the only resilient element which acts on the drive connections 4, 5 and because all the other drive components which are yet to be explained are not self-locking. Therefore, the helical spring force 13 which is produced by the helical spring element 10 corresponds to the total resilient force 9 in the embodiment illustrated as a first approximation.

The illustration according to FIG. 3 shows the total resilient force 9 or the helical spring force 13 versus the position S of the helical spring element 10 which corresponds to a position of the drive connections 4, 5 relative to each other and therefore to a position of the flap 3. FIG. 2 accordingly shows the helical spring element 10 in the position Sₛ which corresponds to the closed position of the flap 3. The position Sₒ of the helical spring element 10 which is merely indicated in FIG. 2 corresponds to the open position of the flap 3. During the closure displacement of the flap 3, the helical spring element 10 therefore passes through the positions Sₒ, Sₖ and Sₛ illustrated in FIG. 3. The curve progression of the total resilient force 9 has between the positions Sₒ and Sₖ of the helical spring element 10 a relatively small curve gradient which increases substantially at the inflexion point Sₖ. This substantial increase of the curve gradient of the curve progression of the total resilient force 9 corresponds to the above-mentioned function of a push-up spring. In this case, an advantage of the solution according to the proposal already becomes evident, according to which the function of a push-up spring can be brought about without a separate resilient element having to be provided therefor.

In this instance, the progressive resilient behavior of the helical spring element 10 according to the proposal is produced in that the helical spring element 10 has a variable resilient configuration along the helical spring axis 11. The term “resilient configuration” is intended to include in this case all the parameters which influence the resilient characteristic of the helical spring element 10. In the embodiment which is illustrated, the helical spring element 10 has a resilient configuration which changes in portions along the helical spring axis 11. This leads to an inflexion point Sₖ which is illustrated in FIG. 3 and which is mentioned above in the resilient characteristic of the helical spring element 10. In accordance with the configuration of the helical spring element 10, this inflexion point Sₖ can be rounded to a greater or lesser extent in the depiction of the characteristic and can also result in a transition which is more or less soft between the curve portions.

In principle, however, it is also conceivable for a resilient configuration which changes continuously to be provided so that there is a constant progressive resilient behavior which does not have an inflexion point but instead a continuous increase of the curve gradient.

Taking FIGS. 2 and 3 together shows that the helical spring element 10 has a spring portion 14 having a first resilient configuration and a spring portion 15 having a second resilient configuration. The spring portion 14 having the first resilient configuration has a comparatively small turn pitch φ₁ while the spring portion 15 having the second resilient configuration has a comparatively large turn pitch φ₂. In this case, it must be considered that in principle a plurality of spring portions 14 having the first resilient configuration and a plurality of spring portions 5 having the second resilient configuration can be provided. It is further conceivable for at least one additional resilient configuration which is accordingly associated with at least one spring portion to be provided.

Very generally, there is provision in the illustrated helical spring element 10 which can result in the different resilient configurations of the helical spring element 10 to differ from each other in terms of the spring geometry. In detail, there is further provision, as mentioned above, for the different resilient configurations of the helical spring element 10 to differ from each other in terms of the turn pitch φ₁, φ₂. The turn pitch is indicated in FIG. 3a for the position S₀ with the angles φ₁ and φ₂.

Alternatively or additionally, there may be provision for the different resilient configurations of the helical spring element 10 to differ from each other in terms of the turn diameter. This may even be advantageous in order to adapt the helical spring element 10 to the respective peripheral conditions in terms of technical structural space. Alternatively or additionally, there may further be provision for the different resilient configurations of the helical spring element 10 to differ from each other in terms of the spring wire diameter. This is particularly advantageous if it is not intended to deviate from the original, particularly cylindrical, formation of the helical spring element 10. The same applies to the configuration which can again be provided alternatively or additionally and in which the different resilient configurations differ from each other in terms of the material parameters of the helical spring material. The material parameters may in particular relate to the rigidity of the helical spring material.

The different turn pitches φ₁, φ₂ mentioned above result, as illustrated in FIG. 3, in different turn spacings d₁, d₂ in the two spring portions 14, 15.

The arrangement is generally carried out in such a manner that the resilient configuration of the helical spring element 10, which configuration changes along the helical spring axis 11, causes spring turns of the helical spring element 10 to be applied during deflection in the case of a displacement, in this instance a closure displacement, of the flap 3 at least in a displacement region of the flap 3, and the resilient number of turns to decrease. The closure displacement of the flap 3 results from the sequence of FIG. 3a, b, c. The transition from FIG. 3a to FIG. 3b shows that the turns w₁, w₂, w₃, w₄ have been applied at the inflexion point sₖ. Starting from the inflexion point sₖ which is illustrated in FIG. 3b, therefore, only the turns w₅, w₆, w₇, w₈ are still resiliently active. The turns w₁, w₂, w₃, w₄ are applied and therefore blocked. In that the spring turns w₅, w₆, w₇, w₈ have a greater turn pitch than the spring turns w₁, w₂, w₃, w₄, with an otherwise identical resilient configuration, there is produced between the position Sₖ and the position Sₛ a greater curve gradient in the curve progression of the total resilient force 9. This is a particularly simple and mechanically robust solution in order to produce the progressive resilient behavior of the helical spring element 10 according to the proposal.

As explained above, the spring turns of the helical spring element 10 are applied in portions, here in the spring portion 14 having the first resilient configuration. Alternatively, however, it is also conceivable for the spring turns to be applied successively during a displacement of the flap 3 so that, as also explained above, a constant progressive resilient progression is produced. The term “applied successively” is intended to be understood to mean that the spring turns are applied individually one after the other during the displacement of the flap 3.

Depending on the configuration of the helical spring element 10, the application of the spring turns can result in a given wear or noise. Against this background, there can be provision for at least the spring turns which are applied to be surface-treated. An example of this is a dry coating of the spring turns in order to reduce the friction between the spring turns which move into engagement.

A particularly simple configuration of the helical spring element 10 is produced in that the spring portions 14, 15 of the helical spring element 10 have a substantially linear resilient characteristic per se in this case. In principle, however, it is also conceivable for the two spring portions 14, 15 each to have per se a progressive resilient behavior again.

Particular significance is attributed in this case to the configuration of the helical spring arrangement 8 with regard to the displacement of the flap 3. In some embodiments, only in the second half, such as in the last third, such as in the last quarter of the closure displacement of the flap 3 does the helical spring arrangement 8 bring about an increase in the total resilient force 9.

In some embodiments, only in the second half, such as in the last third, such as in the last quarter of the closure displacement of the flap 3 does the progressive resilient behavior of the helical spring element 10 bring about an increase in the curve gradient of the curve progression of the total resilient force 9.

The last two construction variants mentioned in relation to the increase of the total resilient force 9, on the one hand, and in relation to the increase in the curve gradient of the curve progression of the total resilient force 9 allow in principle the performance of the function of a push-up spring without a separate resilient element having to be provided therefor.

The solution according to the proposal can be implemented in a particularly simple constructive manner with the embodiment illustrated. In this case, there is provision for the drive arrangement 1 to have a drive motor 16 and a feedgear mechanism 18 which is connected downstream of the drive motor 16, where applicable via an intermediate mechanism 17, in order to produce drive movements which can be directed out via the drive connections 4, 5. The feedgear mechanism 18 is in this case constructed as a linear mechanism in order to produce linear drive movement along a drive axis, wherein the drive axis in the illustrated embodiment which can be in this regard corresponds to the helical spring axis 11. A particularly compact configuration is produced in that the linear mechanism is constructed as a spindle/spindle nut mechanism, wherein the helical spring element 10 can be orientated along the drive axis, such as coaxially relative to the drive axis. In the embodiment illustrated, the helical spring element 10 surrounds the feedgear mechanism 18 which is constructed as a spindle/spindle nut mechanism, which further increases the compactness of the arrangement.

It may be noted that the drive arrangement 1 illustrated in FIG. 2 has a drive housing 19 which can be moved in a telescope-like manner with a displacement of the drive connections 4, 5. All the drive components, in particular the helical screw arrangement 8, are arranged in the housing 19. In principle, however, there may also be provision for the drive arrangement 1 to be arranged with the drive components thereof distributed on the flap 3. There may in particular be provision for at least a portion of the helical spring arrangement 8, in particular the helical spring element 10, to be arranged outside the housing 19.

It may further be noted that the helical spring arrangement 8 may have, in addition to the helical spring element 10, additional helical spring elements in order to achieve the desired curve progression of the total resilient force 9 over a displacement of the drive arrangement 1.

With regard to the fundamental operation of the drive arrangement 1 during the production of motorized drive movements, reference may be made to the German utility model DE 20 2010 016 474 U1 which belongs to the same Applicant and the content of which is hereby incorporated in the subject-matter of the present application in this regard.

According to another embodiment, the above flap arrangement 2 of a motor vehicle is disclosed.

The disclosed flap arrangement 2 has the flap 3 which can be displaced between an open position and a closed position. The flap arrangement 2 further has a drive arrangement 1 which is associated with the flap 3 and which is in accordance with the proposal. Reference may be made to all the explanations in relation to the drive arrangement 1 according to the proposal which are suitable for describing the flap arrangement 2 per se.

1. A drive arrangement of a flap arrangement of a motor vehicle, wherein the flap arrangement has a flap which can be displaced between an open position and a closed position,
wherein the drive arrangement has two mechanical drive connections for the technical drive connection of the drive arrangement and a helical spring arrangement for producing a total resilient force between the two drive connections,
wherein the curve progression of the total resilient force between the two drive connections over a displacement of the drive arrangement has different curve gradients in accordance with the drive position,
wherein the helical spring arrangement has at least one integral helical spring element having a helical spring axis, wherein a displacement of the flap is associated with a deflection of the helical spring element and wherein, in order to produce the curve progression of the total resilient force which has different curve gradients, the helical spring element has a progressive resilient behavior at least over a deflection portion.

2. The drive arrangement as claimed in claim 1, wherein the progressive resilient behavior is produced in that the helical spring element has a variable resilient configuration along the helical spring axis.

3. The drive arrangement as claimed in claim 2, wherein the helical spring element has a resilient configuration which changes in portions or continuously along the helical spring axis.

4. The drive arrangement as claimed in claim 2, wherein the helical spring element has at least one spring portion having a first resilient configuration and at least one spring portion having a second resilient configuration.

5. The drive arrangement as claimed in claim 2, wherein the different resilient configurations of the helical spring element differ in terms of the spring geometry.

6. The drive arrangement as claimed in claim 2, wherein the different resilient configurations of the helical spring element differ from each other in terms of the material parameters of the helical spring material.

7. The drive arrangement as claimed in claim 2, wherein the resilient configuration of the helical spring element which changes along the helical spring axis causes spring turns of the helical spring element to be applied during deflection in the event of a displacement of the flap at least in one displacement region of the flap, and the resilient number of turns to decrease.

8. The drive arrangement as claimed in claim 7, wherein the spring turns of the helical spring element are applied in portions or wherein the spring turns are applied successively during a displacement of the flap.

9. The drive arrangement as claimed in claim 7, wherein at least the applied spring turns are surface-treated.

10. The drive arrangement as claimed in claim 1, wherein at least two spring portions of the helical spring element have per se a substantially linear resilient characteristic.

11. The drive arrangement as claimed in claim 1, wherein in the second half of the closure displacement of the flap, the helical spring element brings about an increase in the total resilient force.

12. The drive arrangement as claimed in claim 1, wherein in the second half of the closure displacement of the flap, the progressive resilient behavior of the helical spring element brings about an increase in the curve gradient of the curve progression of the total resilient force over the displacement of the drive arrangement.

13. The drive arrangement as claimed in claim 1, wherein the drive arrangement has a drive motor and a feedgear mechanism which is connected downstream of the drive motor in order to produce drive movements which can be directed out via the drive connections.

14. The drive arrangement as claimed in claim 13, wherein the feedgear mechanism is constructed as a linear mechanism in order to produce drive movements along a drive axis.

15. A flap arrangement of a motor vehicle having a flap which can be displaced between an open position and a closed position and a drive arrangement which is associated with the flap as claimed in claim 1.

16. The drive arrangement as claimed in claim 4, wherein the helical spring element has at least one spring portion having at least one additional resilient configuration.

17. The drive arrangement as claimed in claim 5, wherein the different resilient configurations of the helical spring element differ from each other in terms of the turn pitch and/or wherein the different resilient configurations of the helical spring element differ from each other in terms of the turn diameter and/or wherein the different resilient configurations of the helical spring element differ from each other in terms of the spring wire diameter.

18. The drive arrangement as claimed in claim 1, wherein in the last quarter of the closure displacement of the flap, the helical spring element brings about an increase in the total resilient force.

19. The drive arrangement as claimed in claim 1, wherein in the last quarter of the closure displacement of the flap, the progressive resilient behavior of the helical spring element brings about an increase in the curve gradient of the curve progression of the total resilient force over the displacement of the drive arrangement.

20. The drive arrangement as claimed in claim 14, wherein the helical spring element is orientated along the drive axis.
